(19) United States
(12) Patent Application Publication
(10) Pub. No.: US 2005/0066583 A1
(43) Pub. Date: Mar. 31, 2005

(54) Fingerguard

(75) Inventors: Giles Newcombe, Sydney (AU); Tony Tapper, Brisbane (AU); Robert McGowan Mann, Exeter (GB)

Correspondence Address: Paul F. Wille, 6407 East Clinton St., Scottsdale, AZ, 85254, US

(73) Assignee: Lorient Polyproducts Ltd., Newton Abbot (GB)

(21) Appl. No.: 10/675,792

(22) Filed: Sep. 29, 2003

(51) Int. Cl. E05F 7/00

(52) U.S. Cl. 49/462

(57) ABSTRACT

A fingerguard is mounted between a support frame and a leaf which is hingedly mounted on the support frame for movement between a closed position and an open position. The leaf has an end edge that is close to the support frame when in its closed position to define a gap that widens on as the leaf moves to its open position. The fingerguard includes a first mounting strip for mounting on the support frame along one side of the gap and a second mounting strip for mounting on the leaf along an opposite side of the gap, a cover strip having a pair of spaced longitudinal edges, one of the longitudinal edges being secured to and along the first mounting strip and the other of the longitudinal edges being secured to and along the second mounting strip such that, in use, the cover strip extends across and prevents access into the gap, the cover strip including a sealing formation on its inner face opposed to the front face of the leaf, the sealing formation in use being held in sealing contact with the front face of the leaf so as to sealingly isolate the gap when the leaf is in its closed position.

### FIELD OF THE INVENTION

The present invention relates to a fingerguard, in particular, but not exclusively a fingerguard which prevents fingers being trapped within a gap formed between a door and door frame.

### SUMMARY OF THE INVENTION

According to one aspect of the invention there is provided a fingerguard for mounting between a support frame and a leaf which is hingedly mounted on the support frame for movement between a closed position and an open position, the leaf having an end edge defined at the juncture of an end face and a front face of the leaf; the end face of the leaf being closely spaced from the support frame when in its closed position to define a gap, the end face being moved away from the support frame to cause said gap to be widened on movement of the leaf to its open position, the fingerguard including a first mounting strip for mounting on the support frame along one side of said gap and a second mounting strip for mounting on said leaf along an opposite side of the gap, a cover strip having a pair of spaced longitudinal edges, one of said longitudinal edges being secured to and along said first mounting strip and the other of said longitudinal edges being secured to and along the second mounting strip such that in use the cover strip extends across and prevents access into said gap, the cover strip including a sealing formation on its inner face opposed to the front face of the leaf; said sealing formation in use being held in sealing contact with said front face of the leaf so as to sealingly isolate said gap when the leaf is in its closed position.

According to another aspect of the present invention there is provided a fingerguard for mounting between a support frame and a leaf which is hingedly mounted on the support frame for movement between a closed position and an open position, the leaf having an end edge defined at the juncture of an end face and a front face of the leaf, the end face of the leaf being closely spaced from the support frame when in its closed position to define a gap, the end face being moved away from the support frame to cause said gap to be widened on movement of the leaf to its open position, the fingerguard including a first mounting strip for mounting on the support frame along one side of said gap and a second mounting strip for mounting on said leaf along an opposite side of the gap, a cover strip having a pair of spaced longitudinal edges, one of said longitudinal edges being secured to and along said first mounting strip and the other of said longitudinal edges being secured to and along the second mounting strip such that in use the cover strip extends across and prevents access into said gap, the cover strip being generally planar and in use extends in a plane generally parallel to the front face of the leaf, the cover being resiliently extensible across its width as defined between said pair of longitudinal edges so as to have a minimum width when the leaf is in its fully closed position and a maximum width when the leaf is in its fully open position.

### BRIEF DESCRIPTION OF THE DRAWINGS

Various aspects of the present invention are hereinafter described with reference to the accompanying drawings, in which:

FIG. 1 is a part perspective view of a fingerguard according to a first embodiment of the invention shown in situ;

FIGS. 2a, 2b are cross-sectional views of the first embodiment shown in a fully contracted and fully extended condition, respectively;

FIG. 3 is a cross-sectional view of a second embodiment according to the present invention.

### DETAILED DESCRIPTION OF THE INVENTION

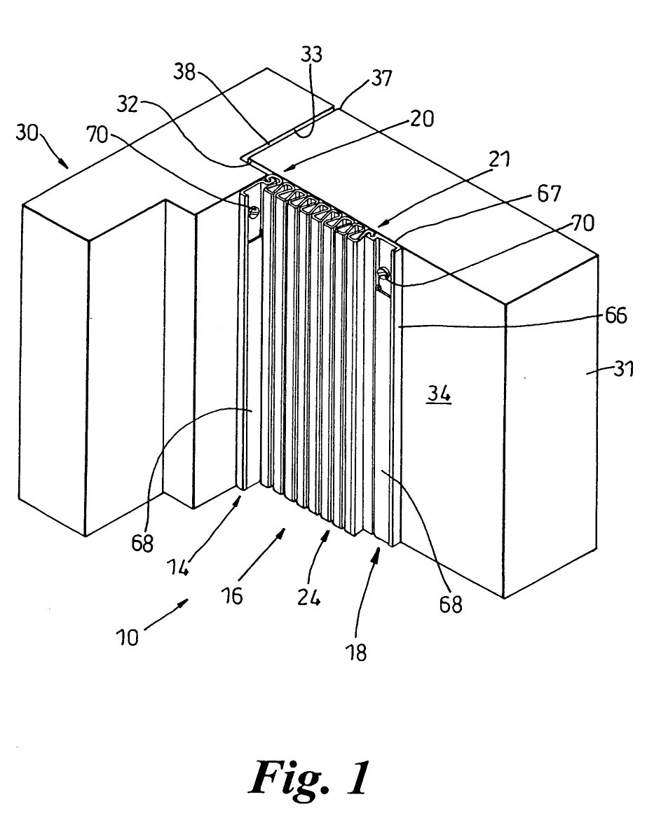

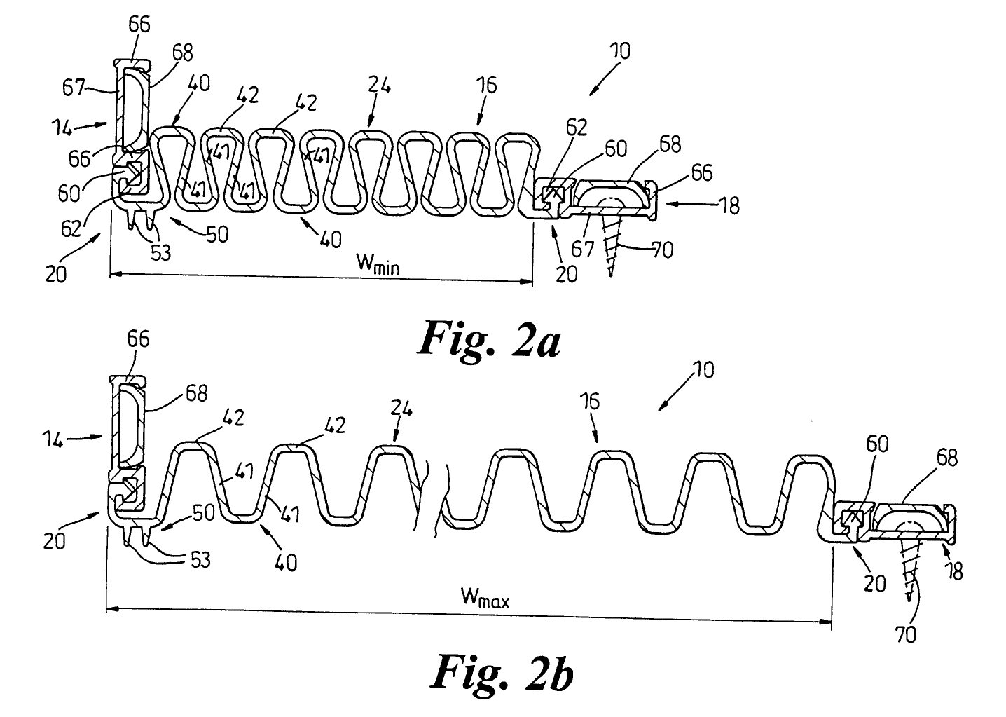

A fingerguard 10 according to a first embodiment of the present invention is illustrated in FIGS. 1 and 2 and comprises a first mounting strip 14, a cover strip 16 and a second mounting strip 18.

The cover strip 16 has a pair of longitudinal sides or edges 20, 21 which are spaced apart from one another to define the width of the cover strip 16.

The cover strip 16, in between the longitudinal sides 20, 21 has a planar body 24 which is adapted such that it is extensible in the widthwise direction whilst remaining substantially planar to enable the width of the cover strip 16 to be increased and decreased between a minimum width dimension and a maximum width dimension (illustrated schematically in FIGS. 2a, 2b, as Wₘᵢₙ, and Wₘₐₓ respectively).

As shown in FIGS. 1 and 2, in use, the fingerguard 10 is mounted on a door frame 30 and door leaf 31. The door leaf 31 has a door edge 32 at the juncture between a door end face 33 and door front face 34.

The door end face 33 is closely spaced from the door frame 30 to define a gap 38 therebetween. The door leaf 31 is hingedly mounted on the door frame 30 so as to be hingedly connected thereto for movement between a fully closed position (as shown in FIG. 1) and a fully open position. The hinge axis about which the door leaf 31 moves is located adjacent to the door edge 37.

Accordingly when the door leaf 31 moves towards its fully open position, the end face 33 moves away from the door frame 30 to cause the gap 38 to widen, particularly in the region of door edge 32.

The first mounting strip 14 is mounted on the door frame 30 close to the front face 34 and along one side of the gap 38. The second mounting strip 18 is mounted on the front face 34 along the opposite side of the gap 38. Accordingly, the cover strip 16 extends across the gap 38 and prevents access into it. The fingerguard 10 preferably extends along the full height of the door leaf 31.

As seen in FIGS. 1 and 2, the first and second mounting strips 14, 18 are arranged at 90° relative to one another with the planar body 24 of the cover strip 16 extending in parallel and along the front face 34.

Accordingly, when the door leaf 31 is moved to its fully open position, the width of the body 24 is extended to its maximum width dimension Wₘₐₓ, and when the door leaf 31 is moved back to its fully closed position, the body 24 is contracted back to its minimum width dimension Wₘᵢₙ.

A minor portion of the planar body 24 is caused to arc across the gap 38 as the door is opened and closed. Thus it will be appreciated that the extension and contraction of the planar body 24 primarily occurs within the plane of the planar body 24 and so the majority of the planar body 24 remains in a plane parallel to the front face 34 during opening and closing of the door leaf 31. This ensures that the fingerguard 10 of the present invention is relatively compact.

To enable the cover strip 16 to extend and contract within a plane, the body 24 is preferably formed from a resilient plastics sheet which is formed into a series of undulations 40 and thereby define a concertina-like body. The undulations 40 are preferably of loop-like shape in cross-section having a pair of legs 41 extending from a base 42. Preferably the pair of legs 41 are inwardly inclined from their associated base 42 and each base 42 is preferably substantially flat. This enables adjacent bases 42 to be located in a closely spaced side by side manner and provide the body 24 with substantially flat outer and inner faces.

It will be appreciated that extension of the body 24 to its maximum width Wₘₐₓ is causes by a pulling force exerted between the mounting strips 14, 18 and that the pulling force causes the legs 41 to bend outwardly relative to their associated base 42.

Preferably the length of the legs 41 is chosen to ensure that extension of the body 24 to its maximum width Wₘₐₓ is accommodated by resilient bending of legs 41 only and not stretching of the plastics sheet from which the Legs 41 are formed.

Preferably the juncture between each leg 41 and their associated base 42 is curved in order to spread the bending stresses evenly.

Contraction of the body 24 from its maximum width Wₘₐₓ to its minimum width Wₘᵢₙ is achieved by resilient recovery of the bent legs 41 back to their original positions as the door leaf is moved back to its fully closed position.

Preferably the cover strip 16 is moulded by extrusion from a suitable elastomer, such as a conventional rubber, a silicone rubber, an ethylene propylene diene monomer or a non-elastomeric material such as flexible polyvinylchloride.

A sealing formation 50 is preferably provided on the inner face of the planar body 24 adjacent to the longitudinal side 20 of the cover strip 16.

The sealing formation 50 extends the full length of the cover strip 16 and preferably comprises two sealing lips 53 which project substantially perpendicularly away from the body 24 towards the front face 34 of the door leaf.

Preferably the lips 53 are integrally connected with the body 24 by being co-extruded therewith. The lips 53 may be formed from the same elastomer from which the body 24 is formed or may be a different extrudable elastomer.

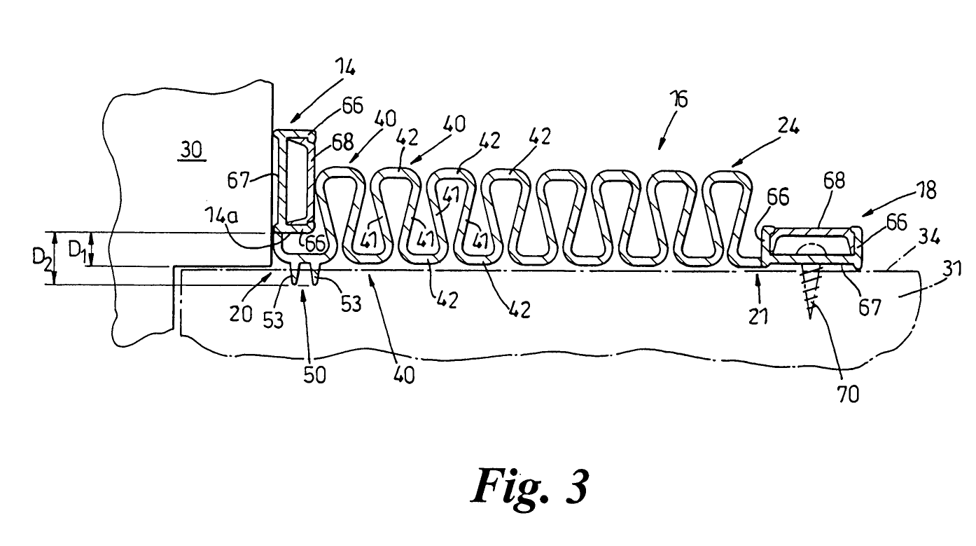

Preferably as illustrated in FIGS. 2 and 3, the sealing formation at least in part underlies the mounting strip 14 such that when the door leaf 31 is in its fully closed position, the sealing formation 50 is directly located between the front face 34 of the door leaf and the facing side 14a of the mounting strip 14.

As schematically illustrated in FIG. 3, the mounting strip 14 is preferably mounted on the frame 30 so that its facing side 14a is spaced from the front face 34 by a distance D₁ which is less than the distance D₂ by which the terminal ends of the lips 53 project from the mounting strip 14.

Accordingly, when the door leaf 31 is in its fully closed position, sealing lips 53 are compressed between the front face 34 and mounting strip 14 and so are resiliently urged into contact with the front face 34 to provide an effective seal.

It will be appreciated that, if desired, the sealing formation 50 may comprise one or more than two sealing lips 53.

It will be appreciated that the sealing formation 50 in combination with the mounting strip 14 and that portion of the cover strip 16 in between the sealing formation 50 and strip 14 form an effective seal to sealingly isolate the gap 38 and so act to prevent smoke or sound passing from one side of the door leaf to the other through the gap 38.

In the embodiment of FIG. 2, the cover strip 16 is provided with enlarged rib formations 60 extending along its opposed longitudinal sides 20, 21. The rib formations 60 enable the sides of the cover strip 16 to be attached to a respective mounting strip 14, 18 by being secured within a closed channel 62 formed in the body of the mounting strip 14, 18. Preferably each rib formation 60 is a push-fit within the receiving channel 62. With this arrangement, the mounting strip 14, 18 may be formed, preferably by extrusion, from any suitable rigid material such as a metal, e.g. aluminium or a plastics material.

Preferably each mounting strip 14, 18 has a main body in the form of an open topped channel having sides 66 and a bottom wall 67.

Preferably the strips 14, 18 are each secured to the frame 30 or door leaf 31 by fixing means 70, such as screws, passing through the bottom wall 67. A capping strip 68 is preferably provided which is a snap-fit between the sides 66; the capping strip 68 serving to hide the fixing means 70 and improve the aesthetic appearance of the mounting strip.

The capping strip 68 is preferably extruded from a rigid or flexible polyvinylchloride.

The embodiment of FIG. 3 is the same as the embodiment of FIG. 2 except for the manner of attachment of the cover strip 16 to the mounting strips 14, 18.

In this respect, in the embodiment of FIG. 3, the sides of the cover strip 16 are integrally connected to the mounting strips 14, 18. Preferably the integral connection is achieved by co-extruding the cover strip 16 and the bodies of the mounting strips 14, 18 from compatible plastics material such as rigid polyvinylchloride or polypropylene.

In the above described embodiments, the leaf comprises a door leaf. It will be appreciated that the term leaf may apply to other types of planar body which are hingedly secured to a frame, such as for example a glazed assembly or window frame.

1. A fingerguard for mounting between a support frame and a leaf which is hingedly mounted on the support frame for movement between a closed position and an open position, the leaf having an end edge defined at the juncture of an end face and a front face of the leaf, the end face of the leaf being closely spaced from the support frame when in its closed position to define a gap, the end face being moved away from the support frame to cause said gap to be widened on movement of the leaf to its open position, the fingerguard including:
a first mounting strip for mounting on the support frame along one side of said gap and a second mounting strip for mounting on said leaf along an opposite side of the gap, a cover strip having a pair of spaced longitudinal edges, one of said longitudinal edges being secured to and along said first mounting strip and the other of said longitudinal edges being secured to and along the second mounting strip such that in use the cover strip extends across and prevents access into said gap, the cover strip including a sealing formation on its inner face opposed to the front face of the leaf, said sealing formation in use being held in sealing contact with said front face of the leaf so as to sealingly isolate said gap when the leaf is in its closed position.

2. A fingerguard according to claim 1 wherein the cover strip is generally planar and in use extends in a plane generally parallel to the front face of the leaf, the cover being resiliently extensible across its width as defined between said pair of longitudinal edges so as to have a minimum width when the leaf is in its fully closed position and a maximum width when the leaf is in its fully open position.

3. A fingerguard according to claim 2 wherein the cover strip, in cross-section, comprises a series of undulations which define a concertina-like body.

4. A fingerguard according to claim 1 wherein the cover strip is extruded from a suitable resilient plastics material, preferably an elastomer.

5. A fingerguard according to claim 4 wherein each mounting strip is an extrusion formed from a suitable rigid material.

6. A fingerguard according to claim 5 wherein the cover strip and each mounting strip are integrally joined by being co-extruded with one another.

7. A fingerguard according to claim 1 wherein the sealing formation is defined by one or more sealing lips projecting from said inner face of the cover.

8. A fingerguard for mounting between a support frame and a leaf which is hingedly mounted on the support frame for movement between a closed position and an open position, the leaf having an end edge defined at the juncture of an end face and a front face of the leaf; the end face of the leaf being closely spaced from the support frame when in its closed position to define a gap, the end face being moved away from the support frame to cause said gap to be widened on movement of the leaf to its open position, the fingerguard including
a first mounting strip for mounting on the support frame along one side of said gap and a second mounting strip for mounting on said leaf along an opposite side of the gap, a cover strip having a pair of spaced longitudinal edges, one of said longitudinal edges being secured to and along said first mounting strip and the other of said longitudinal edges being secured to and along the second mounting strip such that in use the cover strip extends across and prevents access into said gap, the cover strip being generally planar and in use extends in a plane generally parallel to the front face of the leaf, the cover being resiliently extensible across its width as defined between said pair of longitudinal edges so as to have a minimum width when the leaf is in its fully closed position and a maximum width when the leaf is in its fully open position.
